(19) United States
(12) Patent Application Publication
(10) Pub. No.: US 2004/0086309 A1
(43) Pub. Date: May 6, 2004

(54) Conductive brush and method of manufacturing a conductive brush

(76) Inventors: Yasuyuki Ohara, Chiryu-shi (JP); Toyohiro Kanzaki, Chiryu-shi (JP); Masaru Nakayama, Chiryu-shi (JP)

Correspondence Address: SHERIDAN ROSS PC, 1560 BROADWAY, SUITE 1200, DENVER, CO, 80202

(21) Appl. No.: 10/651,511

(22) Filed: Aug. 28, 2003

(30) Foreign Application Priority Data
Oct. 31, 2002 (JP) 2002-318047

(51) Int. Cl. G03G 21/00

(52) U.S. Cl. 399/353

(57) ABSTRACT

A conductive brush comprises a substrate of a belt shape and a plurality of pile yarns extended from the substrate. The substrate and the pile yarns are formed of a same kind of synthetic resin and the pile yarns are adhered to the substrate by a ultrasonic wave. Conductivity is applied to at least a part of the substrate and the pile yarns by including a conductive material in the synthetic resin.

### BACKGROUND OF THE INVENTION

The present invention is related to a conductive brush and a method of manufacturing a conductive brush for wiping toner that is adhered on a photosensitive drum and charging or discharging a surface of the photosensitive drum in an image forming apparatus of an electrophotographic method.

Conventionally, the conductive brush is formed by a base fabric of a woven cloth and a velour material of a plurality of pile yarns that are raised from the base fabric (as disclosed in Japanese Unexamined Patent Publication No. 11-61101). The pile yarns are interwoven with the base fabric by pile weaving and a conductive fiber is partially interwoven with the base fabric. The conductive brush is arranged in a predetermined position in the image forming apparatus via the base fabric. The pile yarns of the conductive brush are contacted to a contact member such as the photosensitive drum to wipe powder such as toner adhered to the photosensitive drum.

However, in the conductive brush of the prior art, a complicated work of interweaving the pile yarns with the base fabric is necessary when manufacturing the conductive brush. The pile yarns that are flocked by interweaving with the basic fabric tend to lie down. When the pile yarns lie down, the pile yarns do not contact the contact member effectively or a part of the pile yarns does not contact the contact member.

### SUMMARY OF THE INVENTION

The present invention solves the problems of the prior art.

To achieve the foregoing an other objectives and in accordance with the purpose of the present invention, a conductive brush including a belt-like substrate and a plurality of pile yarns extended from the substrate is provided. The substrate and the pile yarns are formed of a same kind of a synthetic resin. The pile yarns are adhered to the substrate by an ultrasonic wave. A conductivity is applied to at least a part of the substrate and the pile yarns by adding a conductive material to the synthetic resin.

The present invention provides another conductive brush applied in an image forming apparatus including a contact member, to which powder is adhered by static electricity, and a support member arranged corresponding to the contact member. The conductive brush includes a substrate supported by the support member and a plurality of pile yarns extended from the substrate. The pile yarns contact the contact member. The support member is formed of a material having conductivity. The static electricity generated at the powder or the contact member is electrically conducted to the support member via the pile yarns and the substrate.

Further, the present invention provides a manufacturing method of a conductive brush. The method includes: a winding step of moving an endless belt and winding pile yarns spirally around the endless belt; a substrate supply step of supplying two substrates of a belt shape to two sides of the endless belt with respect to the pile yarns wound around the endless belt; an adhering step of contacting the supplied substrate with the pile yarns and adhering the substrate to the pile yarns by ultrasonic wave vibration; a cutting step of cutting an intermediate portion of pile yarns at opposite surfaces of the endless belt; and a separation step of separating the pile yarns and the substrate away from the endless belt.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a conductive brush according to one embodiment of the present invention;

FIG. 2 is a cross-sectional view showing a state in which the conductive brush of FIG. 1 is used in an image forming apparatus;

FIG. 3(a) is a schematic view of an apparatus for manufacturing a conductive brush seen from a plane surface;

FIG. 3(b) is a schematic view of the apparatus for manufacturing a conductive brush seen from a side surface;

FIGS. 4(a) to 4(c) are schematic diagrams showing pile yarns according to another embodiment;

FIGS. 5(a) and 5(b) are schematic diagrams showing a substrate according to another embodiment; and

FIG. 6 is a front view of a conductive brush according to another embodiment.

### DETAILED DESCRIPTION OF THE PREFERRED EMBODIMENTS

Hereinafter, one embodiment of the present invention will be explained with reference to the drawings.

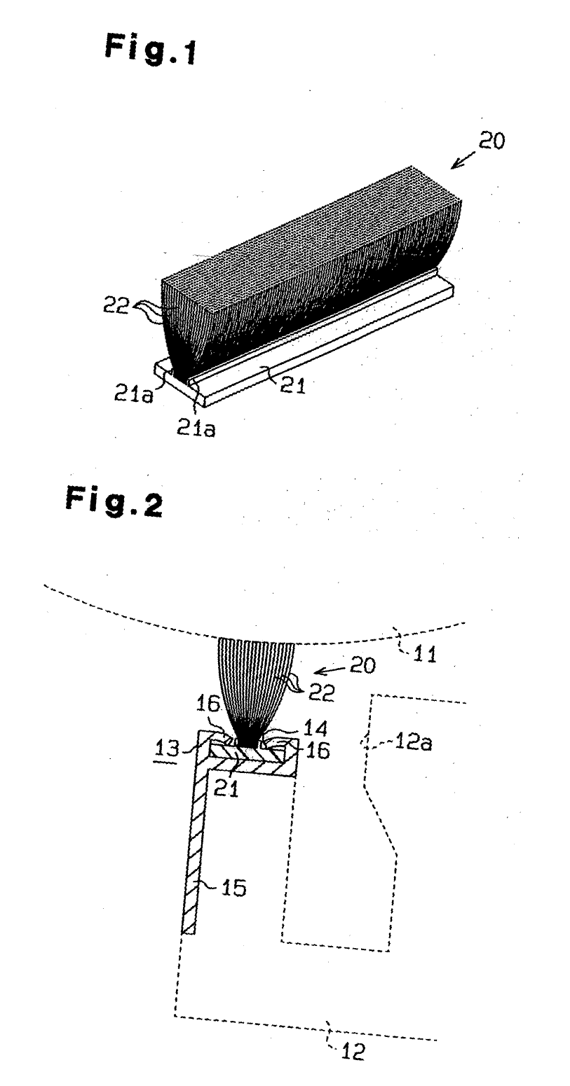

As shown in FIG. 1, a conductive brush 20 comprises a substrate 21 of a belt and a plurality of pile yarns 22 that are flocked on the substrate 21.

The substrate 21 is formed by a film of a synthetic resin that has excellent durability and abrasion resistant and that has a low coefficient of dynamic friction. Such a synthetic resin includes olefin resin such as polypropylene and ultrahigh molecular polyethylene, amide resin such as aliphatic polyamide and aromatic polyamide, acrylic resin such as polyacrylamide, ester resin such as polyethylene terephthalate, and fluororesin. Two guide projections 21a for positioning the pile yarns 22 are provided at an intermediate portion of the substrate 21 in its width direction. The guide projections 21a are extended parallel with each other along a longitudinal direction of the substrate 21 with a predetermined distance there between.

The pile yarns 22 are formed by yarns such as filament yarns or spun yarns. Each of the pile yarns 22 is bent in an almost U-shape and is adhered between the guide projections 21a of the substrate 21. The pile yarns 22 are adhered to the substrate 21 by an adhering method using a ultrasonic wave. This is because the method using a ultrasonic wave firmly adheres the pile yarns 22 to the substrate 21 without affecting the shapes of the portions of the yarns 22 that are not adhered to the substrate 21. The pile yarns 22 are adhered to a center portion of the substrate 21 in its width direction and the conductive brush 20 is formed so that a cross-sectional surface of the substrate 21 forms an upside down T-shape.

Fiber having excellent durability and abrasion resistant and low coefficient of dynamic friction is used for the pile yarns 22. An example of such fiber is a synthetic fiber that includes a synthetic resin used for the substrate 21. The synthetic fiber that is used for the pile yarns 22 includes a synthetic resin that is in a same group as the synthetic resin that is used for the substrate 21 so that the adherence is stronger when the pile yarns 22 are adhered to the substrate 21 by an ultrasonic wave. Out of the above-described synthetic resin, olefin resin, particularly polypropylene is superior in durability and abrasion resistance and is easy to be obtained and also has high compatibility. Therefore, polypropylene is suitable for adherence by a ultrasonic wave and preferable for the substrate 21 and the pile yarns 22.

A conductive material is mixed with and included in the synthetic resin that is used for the substrate 21 and the pile yarns 22. Examples of the conductive material include metal such as silver, copper, and nickel, metal compound such as zinc oxide and tin oxide, and a fine grain such as carbon. Since the conductive material is mixed with the synthetic resin for the substrate 21 and the pile yarns 22, conductivity is applied to the substrate 21 and the pile yarns 22 so that electricity is conducted therein. In this embodiment, polypropylene including carbon is used for the substrate 21 and the pile yarns 22.

The conductive brush 20 is arranged in a predetermined position and used in the image forming apparatus of an electrophotographic method. As shown in FIG. 2, a photosensitive drum 11 that serves as a movable member is rotatably supported in the image forming apparatus. A charge mechanism, an expose mechanism, a transfer mechanism, and a cleaning mechanism (not shown) are arranged in the vicinity of the photosensitive drum 11 so as to surround the photosensitive drum 11. Toner is supplied to the charged surface of the photosensitive drum 11 and a visible image formed by the toner is transferred to a recording paper. The toner remains on the surface of the photosensitive drum 11 right after the visible image is transferred. The cleaning mechanism removes the remaining toner.

A support member 13 is arranged in a housing 12 that includes the cleaning mechanism so as to face the photosensitive drum 11. The support member 13 is hollow and has a rectangular cross-section, and has an opening 14 on a surface that faces the photosensitive drum 11. A fixing portion 15 is extended from one side surface of the support member 13. The fixing portion 15 fixes the support member 13 to the housing 12. Two projections 16 are formed at open ends of the support member 13 so that the opening 14 is restricted to a predetermined width. The support member 13 is formed of metal such as iron, copper and aluminum or alloy of such metals and has conductivity.

The substrate 21 is inserted into the support member 13 so that the conductive brush 20 is supported by the support member 13. The two projections 16 are bent toward the inside of the support member 13 so that the substrate 21 is pressed toward the inner bottom surface of the opening 14 by the two projections 16. Thus, the conductive brush 20 is fixed to the support member 13. The pile yarns 22 of the conductive brush 20 are extended from the opening 14 so that distal ends of the pile yarns 22 contact the surface of the photosensitive drum 11.

The toner is adhered to the surface of the photosensitive drum 11 by static electricity. Since the pile yarns 22 have conductivity, the static electricity of the photosensitive drum 11 or the toner is transferred to the pile yarns 22 when contacting the photosensitive drum 11 and the static electricity is removed from the photosensitive drum 11 or the toner. The static electricity is removed from the toner and the toner is easy to be free from the surface of the photosensitive drum 11. The toner is wiped from the surface of the photosensitive drum 11 by the pile yarns 22. The wiped toner is captured by the pile yarns 22 or collected inside the housing 12 via the collecting port 12a provided in the housing 12 to be removed.

On the other hand, not only the pile yarns 22 but also the substrate 21 of the conductive brush 20 has conductivity. The substrate 21 contacts the conductive support member 13, which is fixed thereto. The substrate 21 and the support member 13 are electrically conducted to each other. Therefore, the static electricity that is transferred to the pile yarns 22 is conducted to the support member 13 via the substrate 21 and discharged outside the housing 12 from or via the support member 13.

Shore hardness of the substrate 21 that is defined by JIS Z 2246 is preferably in a range of 10 to 90 in D scale. If the Shore hardness is smaller than 10, the substrate 21 is easy to be twisted or bent and troublesome may be caused when arranged in the support member 13. If the Shore hardness is higher than 90, the adherence by the ultrasonic wave may become difficult, or it may be difficult to form the substrate 21 in a predetermined shape, or the substrate 21 may be difficult to be cut.

Single yarn fineness of the pile yarns 22 is preferably in a range of 3 to 100 decitex, more preferably in a range of 5 to 20 decitex so that the movable member is not damaged when the pile yarns 22 contact the movable member, such as the photosensitive drum 11. The single yarn fineness is fineness of a single yarn that is a part of the pile yarns 22 when a yarn (multifilament yarn) that is formed by twisting a plurality of fibers is used for the pile yarns 22. As the single yarn fineness becomes smaller, the rigidity of the pile yarns 22 becomes smaller. Accordingly, the pile yarns 22 may lie down or may be cut. As the single yarn fineness becomes larger, the flexibility of the pile yarns 22 becomes smaller. Accordingly, the slide resistance is increased and the movable member is damaged frequently.

The fineness of the pile yarn 22 is preferably in a range of 100 to 2000 decitex, more preferably 300 to 1500 decitex. Other than the multifilament yarn, a yarn formed of single fiber (monofilament yarn) may be used for the pile yarns 22. It is preferable to set the fineness of the pile yarn 22 within the above-described range so as to prevent the movable member from being damaged or the slide resistance from being increased. As the fineness of the pile yarns 22 becomes smaller, the rigidity of the pile yarns 22 is smaller. Accordingly, the pile yarns 22 may lie down or may be cut. As the fineness of the pile yarns 22 becomes larger, the flexibility of the pile yarns 22 becomes smaller. Accordingly, the slide resistance is increased and the movable member is damaged frequently.

The total value of volume resistivity of the substrate 21 and the pile yarns 22 of the conductive brush 20 is preferable in a range of 10¹ to 10⁸ Ω·cm. The total value of the volume resistivity is measured by a method of JIS K 6911 and is a value of resistance of a current that flows through the substrate 21 and the pile yarns 22 when a voltage is applied to the substrate 21 and the pile yarns 22. Therefore, as the total value of volume resistivity is lower, it is superior in conductivity.

The total value of volume resistivity of the pile yarns 22 is preferable in a range of 10¹ to 10⁴ Ω·cm. If the total value of volume resistivity is smaller than 10¹ Ω·cm or if the value of volume resistivity of the pile yarns 22 is smaller than 10¹ Ω·cm, the electric resistance may not be maintained stably influenced by the working environment. If the total value of volume resistivity is higher than 10⁸ Ω·cm or if the value of volume resistivity of the pile yarns 22 is higher than 10⁴ Ω·cm, the static electricity cannot be sufficiently removed and remains unevenly. Accordingly, the obtained image may be deteriorated when the conductive brush 20 is used in the image forming apparatus.

The value of volume resistivity of the substrate 21 is preferably more than or equal to the value of volume resistivity of the pile yarns 22 so as to maintain the electric resistance of the whole conductive brush 20 stably without influenced by the working environment. If the value of volume resistivity of the substrate 21 is smaller than that of the pile yarns 22, the electric resistance of the substrate 21 is not stable and it is difficult to set the value of volume resistivity of the whole conductive brush 20 within a range of 10¹ to 10⁸ Ω·cm.

To set the value of volume resistivity of the whole conductive brush 20 within the above-described range, while the value of volume resistivity of the pile yarns 22 is set within the above-described range, the value of volume resistivity of the substrate 21 is changed precisely in correspondence with the value of volume resistivity of the pile yarns 22 so as to set the desired value of volume resistivity of the conductive brush 20. This is because the substrate 21 has a stable value of volume resistivity and it is easy to adjust the value of volume resistivity of the substrate 21 compared to the pile yarns 22 made by a plurality of fabrics. When the value of volume resistivity of the conductive brush 20 is adjusted by changing the substrate 21, the substrate 21 is easy to be exchanged compared to the pile yarns 22 when manufacturing the conductive brush 20. Accordingly, a plurality of conductive brushes 20 having different values of volume resistivity are manufactured efficiently.

Next, a manufacturing apparatus for manufacturing the conductive brush 20 will be explained.

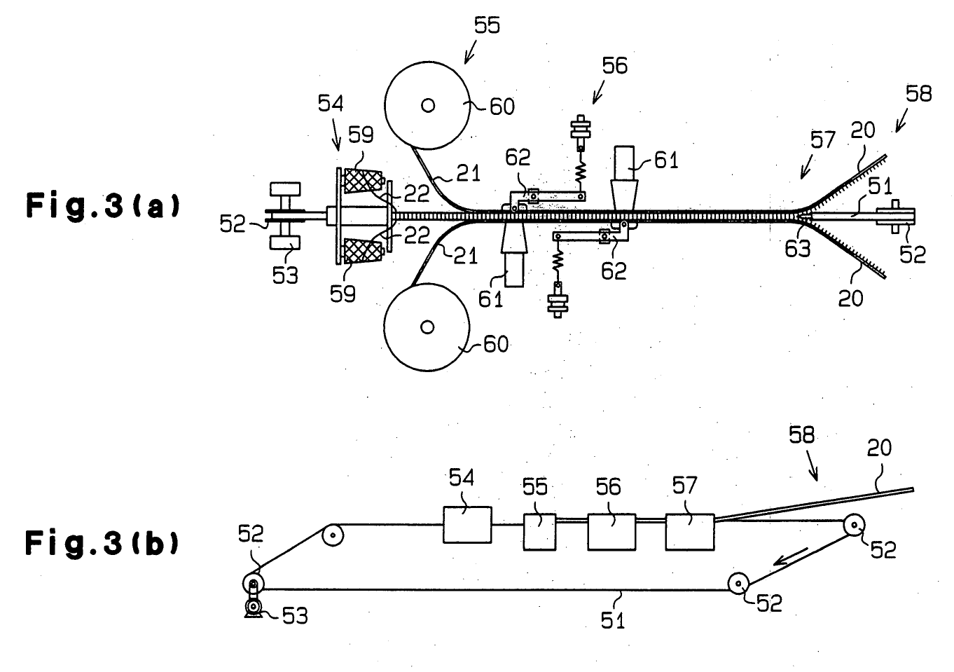

As shown in FIGS. 3(a) and 3(b), the manufacturing apparatus has an endless belt 51 that is formed by connecting two ends of a belt member. The endless belt 51 is arranged between a plurality of rollers 52. In FIGS. 3(a) and 3(b), when the left-side roller 52 is rotated by a drive device 53, the endless belt 51 moves around in the apparatus. A pile yarn supply mechanism 54, a substrate supply mechanism 55, an adhering mechanism 56, a cutting mechanism 57, and a collecting mechanism 58 are arranged in the order from the left side between the left-side roller 52 and the right-side roller 52.

The pile yarn supply mechanism 54 includes two bobbins 59 that face with each other so that the endless belt 51 is located there between. The bobbins 59 are arranged in the vicinity of the upper traveling portion of the endless belt 51. The bobbins 59 are rotatable and supply the pile yarn 22 to a surface of the endless belt 51. The substrate supply mechanism 55 includes two supply drums 60 that face with each other so that the endless belt 51 is located there between. The substrate 21 is wound around the supply drums 60. The substrate 21 that is pulled out from each supply drum 60 is supplied to the sides of the endless belt 51 along the movement direction of the endless belt 51 and moves parallel to the endless belt 51.

The adhering mechanism 56 includes two horns 61 and two press members 62. The horns 61 transfer the ultrasonic vibration to the substrate 21 and the press members 62 press the substrate 21 to the endless belt 51. A pair of the horn 61 and the press member 62 held the endless belt 51 there between, and the pairs of the horn 61 and the press member 62 are arranged alternately with respect to the movement direction of the endless belt 51. The cutting mechanism 57 has a pair of cutting blades 63. One of the cutting blades 63 is located at a lower side, and the other one is located at an upper side of the endless belt 51 (one cutting blade 63 is shown). The cutting blade 63 is arranged at a center of the width direction of the endless belt 51. The collecting mechanism 58 includes a cutting portion (not shown) that is arranged on two sides of the endless belt 51. A pair of conductive brushes 20 that are supplied to the cutting portion are cut into a predetermined length and collected.

Next, a manufacturing method of the conductive brush 20 will be explained.

The conductive brush 20 is manufactured with the manufacturing apparatus shown in FIGS. 3(a) and 3(b) by the procedure of a winding step, a substrate supply step, an adhering step, a cutting step, and a separation step.

The winding step is carried out in the pile yarn supply mechanism 54 of the manufacturing apparatus for winding the pile yarn 22 around the surface of the endless belt 51. In the pile yarn supply mechanism 54, the two bobbins 59 are arranged in the vicinity of the upper traveling portion of the endless belt 51. The bobbins 59 are rotatable and supply the pile yarn 22 onto the endless belt 51. The number of flocked hairs of the pile yarn 22 is adjusted by adjusting the rotational speed of the bobbins 59 and the supply amount and the supply speed of the pile yarn 22 in the pile yarn supply mechanism 54. The height of the pile yarns 22 from the substrate 21 is adjusted by changing the width of the endless belt 51. The pile yarn 22 that is supplied onto the endless belt 51 is wound around the surface of the endless belt spirally and moves rightward with the endless belt 51.

In the substrate supply step that is carried out in the substrate supply mechanism 55 of the manufacturing apparatus, the substrate 21 is supplied from two sides of the endless belt 51 to the pile yarn 22 that is wound around the endless belt 51. In the substrate supply mechanism 55, the substrate 21 that is pulled out from each supply drum 60 is supplied to each of the two sides of the endless belt 51. At this time, the substrate 21 and the pile yarn 22 are positioned so that the pile yarn 22 that is wound around the endless belt 51 is between two guide projections 21a that are arranged on the substrate 21.

In the adhering step that is carried out in the adhering mechanism 56 of the manufacturing apparatus, the supplied substrate 21 contacts the pile yarns 22 to adhere the substrate 21 and the pile yarns 22 by the ultrasonic wave. In the adhering mechanism 56, the substrate 21 is pressed from one side of the endless belt 51 by the press member 62 to contact the pile yarns 22 and the horn 61 contacts the substrate 21 from the other side of the endless belt 51. The ultrasonic wave vibration is transferred to the substrate 21 via the horn 61 and the substrate 21 and the pile yarns 22 are adhered to each other at the contact portion by the ultrasonic wave vibration.

In the cutting step that is carried out in the cutting mechanism 57 of the manufacturing apparatus, the wound portion of the pile yarn 22 that is wound around the endless belt 51 is cut at its intermediate portion and released from the endless belt 51. In the cutting mechanism 57, the two cutting blade 63 cut the center of the wound portion of the pile yarn 22 that is positioned at an upper and a lower side of the upper traveling portion of the endless belt 51 respectively.

In the cutting mechanism 57, two conductive brushes 20 are manufactured by released from the two sides of the endless belt 51.

In the separation step that is carried out in the collecting mechanism 58, the pile yarns 22 are separated from the endless belt 51 with the substrate 21 and the manufactured conductive brushes 20 are collected. In the collecting mechanism 58, two conductive brushes 20 on the endless belt 51 are pulled to the two sides of the endless belt 51 respectively. Then, the pile yarns 22 are pulled out of the endless belt 51 and the conductive brushes 20 are separated from each other.

The two conductive brushes 20 that are separated from the endless belt 51 are cut into a predetermined length by the cutting portion and the conductive brushes 20 of a linear shape are collected.

In the conductive brush 20 that is obtained by the above-described manufacturing method, the number of the pile yarns 22 that are flocked on the substrate 21 is preferably in a range of 5000 to 50000, more preferably in a range of 5000 to 20000 per one-inch length of the substrate 21. As the number of flocked yarns per one-inch length is decreased, the density of the pile yarns 22 on the substrate 21 is decreased and more space is formed between the pile yarns 22. Therefore, deterioration is caused in wiping and capturing an object such as toner adhered onto the movable member. As the number of flocked yarns per one-inch length is increased, the density of the pile yarns 22 on the substrate 21 is increased. Accordingly, the slide resistance is increased and the movable member may be damaged frequently.

The advantages of the above embodiment will be described below.

The conductive brush 20 of this embodiment comprises the substrate 21 of a belt and pile yarns 22 that are flocked on the substrate 21. The pile yarns 22 are adhered onto the substrate 21 by a ultrasonic wave and its structure is simple compared to the velour material of a prior art. The pile yarns 22 that are adhered to the substrate 21 are melted with the substrate at the adhering portion and fixed to the substrate 21 so as not to be unstable at the root. Therefore, the pile yarns 22 are prevented from lying down with simplifying the manufacturing method of the conductive brush 20.

The value of volume resistivity of the conductive brush 20 is within a range of 10¹ to 10⁸ Ω·cm. Therefore, the electric resistance value is maintained stably and the conductive brush 20 has preferable conductivity.

The conductive brush 20 is supported by the conductive support member 13 in the image forming apparatus and electrically conducted with the support member 13 via the substrate 21. This configuration prevents the conductive brush 20 from being electrically charged with the static electricity that is removed from the movable member and toner. The conductive brush 20 thus has a satisfactory conductivity for an extended period.

The value of volume resistivity of the pile yarn 22 is within a range of 10¹ to 10⁴ Ω·cm and the value of volume resistivity of the substrate 21 is adjusted so as to be more than or equal to that of the pile yarn 22. The value of volume resistivity of the conductive brush 20 is adjusted by changing the value of volume resistivity of the substrate 21 according to the value of volume resistivity of the pile yarns 22. Since the value of volume resistivity of the substrate 21 is more stable than that of the pile yarns 22, the value of volume resistivity of the conductive brush 20 is easily adjusted. Since the substrate 21 is easy to be exchanged compared to the pile yarns 22 when manufacturing the conductive brush 20, the conductive brushes 20 of different kinds having different value of volume resistivity are manufactured efficiently.

Two conductive brushes 20 are manufactured by one procedure including the winding step for winding the pile yarn 22 around the endless belt 51, the substrate supply step for supplying the substrate 21 from the two sides of the endless belt 51 where the pile yarn 22 is wound, the adhering step for adhering the substrate 21 and the pile yarns 22 by the ultrasonic wave, and the cutting step for cutting the pile yarns 22. The manufactured two conductive brushes 20 are separated from the endless belt 51 and are collected in the separation step. A large amount of conductive brushes 20 can be manufactured almost automatically with low cost and without a complicated procedure.

Since the pile yarn 22 is wound around and supported by the endless belt 51 in each step, the pile yarn 22 is prevented from lying down during the procedure. Moreover, the distal ends of the pile yarns 22 are not necessary to be cut in another step so that the length of the pile yarns 22 becomes equal. The pile yarns 22 that are obtained by the manufacturing method of this embodiment have their distal ends with precisely equal length. Therefore, the conductive brush 20, having its distal ends with precisely equal length, is manufactured with a simplified manufacturing method that prevents the lying down of the pile yarns 22. The conductive brush 20 is collected in a linear shape in the collecting mechanism 58 of the separation step. Accordingly, the pile yarns 22 are certainly prevented from lying down compared to collecting the conductive brush 20 by winding around a drum.

The Shore hardness of the substrate 21 is set in a range of 10 to 90 in the D scale. Therefore, the substrate 21 is prevented from twisted or bent and the conductive brush 20 is easily arranged in the support member 13. Additionally, the pile yarns 22 are prevented from lying down during the transportation of the conductive brush 20, since the substrate 21 is not twisted or bent.

It should be apparent to those skilled in the art that the present invention may be embodied in many other specific forms without departing from the spirit or scope of the invention. Particularly, it should be understood that the invention may be embodied in the following forms.

Conductivity need not be applied to all the pile yarns 22 that are flocked onto the substrate 21, but an insulating yarn of a normal synthetic fiber may be used for a part of a plurality of pile yarns 22. In this case, the material cost is decreased and the manufacturing cost is also decreased. If the fineness of the pile yarn of the insulating yarn is differentiated from the fineness of the pile yarn 22 having conductivity, the slide resistance is easily decreased and the movable member is easily protected from damage. The material of the synthetic fiber that is used for the insulating yarn and the material of the conductive yarn are a synthetic resin of a same group that is used for the substrate 21. In other words, synthetic resin of a same group is necessarily used for the substrate 21, the conductive pile yarn, and the insulating pile yarn. The same synthetic resin is not necessarily used for the substrate 21, the conductive pile yarn and the insulating pile yarn but different synthetic resins may be used.

The pile yarns 22 and the substrate 21 are not necessarily formed by only a synthetic resin including a conductive material as shown in the above embodiment, but the pile yarns 22 and the substrate 21 must have at least partial conductivity.

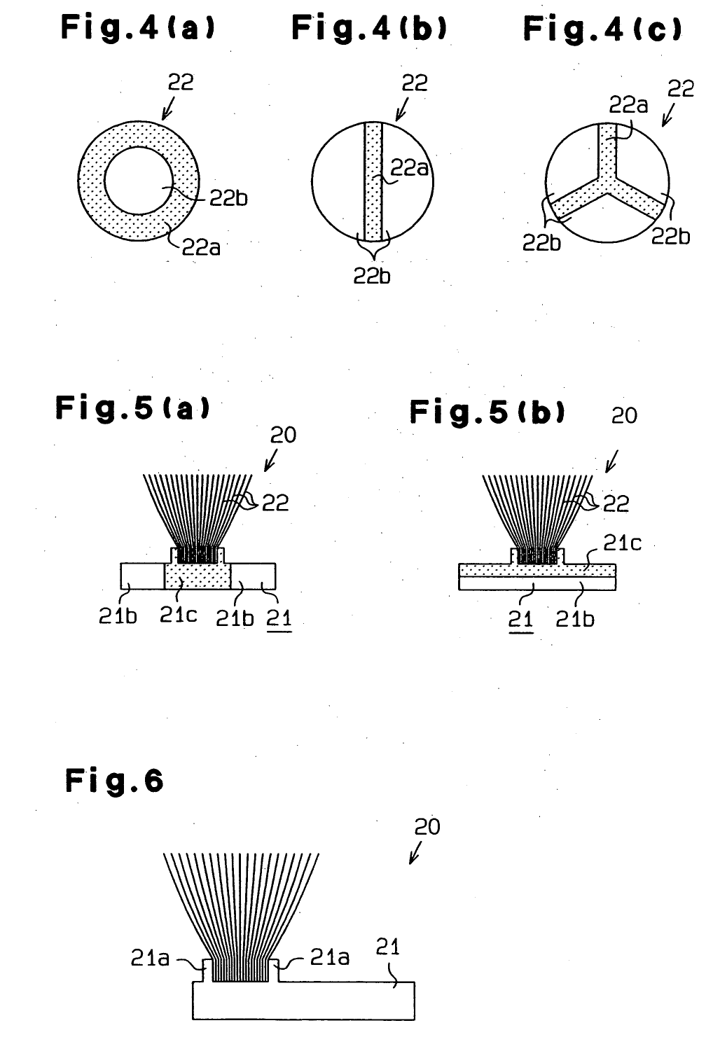

For example, as shown in FIGS. 4(a) to 4(c), the pile yarn 22 may have a conductive portion 22a and an insulating portion 22b. The conductive portion 22a is made by a synthetic resin including a conductive material and the insulating portion 22b is made by a synthetic resin that does not include a conductive material. The pile yarn 22 having the conductive portion 22a and the insulating portion 22b are formed by a multi-component fiber spinning method. In this case, the pile yarn 22 has its conductivity at the conductive portion 22a. The pile yarn 22 shown in FIG. 4(a) has the conductive portion 22a on its peripheral surface and the insulating portion 22b in its inner portion. Therefore, the amount of the conductive material required for the pile yarn 22 is decreased with preferably maintaining its conductivity, and accordingly the manufacturing cost is decreased.

In the pile yarn 22 shown in FIG. 4(b), the conductive portion 22a is formed linearly along a radial direction of the pile yarn 22. Therefore, the manufacturing cost is decreased and the conductive portion 22a is prevented from being exposed to the outside, and the value of volume resistivity is prevented from being decreased due to influences of the working environment.

In the pile yarn 22 shown in FIG. 4(c), the conductive portion 22a is formed so as to be extended radially from the center of the pile yarn 22 toward three outer directions with an equal distance there between. Therefore, the manufacturing cost is decreased and the conductive portion 22a is prevented from being exposed to the outside. The conductive portion 22a contacts the contact member with a unified area and the pile yarn 22 has a preferably stable conductivity.

As shown in FIGS. 5(a) and 5(b), the substrate 21 may have a conductive portion 21c, formed by a synthetic resin including a conductive material, and a non-conductive portion 21b, formed by a synthetic resin not including a conductive material. In this case, the substrate 21 has its conductivity at the conductive portion 21c. In the substrate 21 shown in FIG. 5(a), a portion where the pile yarns 22 are flocked corresponds to the conductive portion 21c and two ends of the conductive portion 21c correspond to the non-conductive portion 21b. Therefore, the electrical conductivity between the pile yarns 22 and the support member 13 is maintained preferably. Also the required amount of the conductive material is decreased and the manufacturing cost is decreased.

In the substrate 21 shown in FIG. 5(b), a surface of the substrate 21 where the pile yarns 22 are flocked is comprised of the conductive portion 21c and a rear side of the substrate 21 is comprised of the non-conductive portion 21b. In this case, the manufacturing cost is decreased and the electrical conductivity between the pile yarns 22 and the support member 13 is maintained by the contact of the conductive portion 21c and the projections 16 of the support member 13.

In the conductive brush 20, the pile yarns 22 are not necessarily flocked at the center of the substrate 21 in its width direction, as shown in FIG. 1. For example, as shown in FIG. 6, the pile yarns 22 may be flocked at the offset position from the center to the side in its width direction of the substrate 21. In this case, the contact pressure and the contact angle with respect to the contact member are adjusted easily and accurately without changing the fineness of the pile yarns 22 and the number of the flocked pile yarns 22.

If the value of volume resistivity of the conductive brush 20 can be set in a range of 10¹ to 10⁸ Ω·cm, the value of volume resistivity of the pile yarns 22 is not necessarily set in a range of 10¹ to 10⁴ Ω·cm and the value of volume resistivity of the pile yarns 22 may be set outside the range. Instead of adjusting the value of volume resistivity of the conductive brush 20 by changing the value of volume resistivity of the substrate 21 according to the value of volume resistivity of the pile yarns 22, the value of volume resistivity of the conductive brush 20 may be adjusted by changing the value of volume resistivity of the pile yarns 22 according to the value of volume resistivity of the substrate 21.

The substrate 21 is not necessarily formed of a film but may be formed of a woven cloth, a knitted cloth, a non-woven cloth, or a sheet if the material is a synthetic resin that can adhere the pile yarn 22 to the substrate 21 by a ultrasonic wave.

A sticking layer may be formed on a rear surface of the substrate 21 by coating a pressure sensitive adhesive of a rubber group or an acryl group over the rear surface of the substrate 21 or sticking a double-sided adhesive tape on the rear surface of the substrate 21. The double-sided adhesive tape is obtained by coating the pressure sensitive adhesive over two sides of a core material. The conductive brush 20 may be stuck to the support member via the sticking layer. In this case, the adhesive of the sticking layer preferably includes the above-described conductive material so as to maintain the conductivity between the substrate 21 and the support member.

The conductive brush 20 is not necessarily arranged in the cleaning mechanism but may be arranged in the developing mechanism or the charging mechanism. The movable member may be comprised of a transfer belt for transferring a recording paper to the transfer mechanism and the conductive brush 20 may be arranged in the transfer mechanism so that the distal ends of the pile yarns 22 contact the transfer belt.

The conductive brush 20 is not necessarily arranged in the image forming apparatus but may be used for cleaning a powder particle feeding roller or a conveyer. The powder particle feeding roller is arranged in a wrapping machine for wrapping medicine of fine powder particles (powder or granule). The conveyer is arranged in a manufacturing factory for transferring moldings when the molding such as a film is processed. The conductive brush 20 may be used for cleaning a lens of an information reading device and a sheet insertion opening of a reading device such as a cash card insertion opening of an automatic money withdrawer in a bank, a telephone card insertion opening of a public telephone or a paper money insertion opening of a vending machine. The conductive brush 20 may be used as a cleaning brush for cleaning a surface of an optical disc and a lens for reading information from an information recording medium such as an optical magnetic disc, and an information display device such as a liquid crystal display and an organic display. The conductive brush 20 may be arranged at a suction opening of a vacuum cleaner for wiping dust.

Therefore, the present examples and embodiments are to be considered as illustrative and not restrictive and the invention is not to be limited to the details given herein, but may be modified within the scope and equivalence of the appended claims.

1. A conductive brush comprising:
a belt-like substrate; and
a plurality of pile yarns extended from the substrate,
wherein the substrate and the pile yarns are formed of a same kind of a synthetic resin, and the pile yarns are adhered to the substrate by an ultrasonic wave, and a conductivity is applied to at least a part of the substrate and the pile yarns by adding a conductive material to the synthetic resin.

2. The conductive brush according to claim 1, wherein a total value of volume resistivity of the substrate and the pile yarns is in a range of 10¹ to 10⁸ ∩·cm.

3. The conductive brush according to claim 1, wherein a value of volume resistivity of the pile yarns is in a range of 10¹ to 10⁴ Ω·cm and the value of volume resistivity of the substrate is equal to or greater than that of the pile yarns.

4. The conductive brush according to claim 1, wherein the pile yarns are formed of one of a multifilament yarn and a monofilament yarn, and the fineness of the yarn is in a range of 100 to 2000 decitex.

5. The conductive brush according to claim 1, wherein the substrate and the pile yarns are formed of polypropylene.

6. The conductive brush according to claim 1, wherein the conductive material is carbon.

7. A conductive brush applied in an image forming apparatus including a contact member, to which powder is adhered by static electricity, and a support member arranged corresponding to the contact member, the conductive brush comprising:
a substrate supported by the support member; and
a plurality of pile yarns extended from the substrate,
wherein the pile yarns contact the contact member, and wherein the support member is formed of a material having conductivity, and the static electricity generated at the powder or the contact member is electrically conducted to the support member via the pile yarns and the substrate.

8. The conductive brush according to claim 7, wherein a total value of volume resistivity of the substrate and the pile yarns is in a range of 10¹ to 10⁸ Ω·cm.

9. The conductive brush according to claim 7, wherein a value of volume resistivity of the pile yarns is in a range of 10¹ to 10⁴ Ω·cm and the value of volume resistivity of the substrate is equal to or greater than that of the pile yarns.

10. The conductive brush according to claim 7, wherein the pile yarns are formed of one of a multifilament yarn and a monofilament yarn and the fineness of the yarn is in a range of 100 to 2000 decitex.

11. The conductive brush according to claim 7, wherein the substrate and the pile yarns are formed of polypropylene.

12. The conductive brush according to claim 7, wherein the material having conductivity is carbon.

13. The conductive brush according to claim 7, wherein the number of the pile yarns is in a range of 5000 to 50000 per one-inch length of the substrate.

14. A manufacturing method of a conductive brush including:
a winding step of moving an endless belt and winding pile yarns spirally around the endless belt;
a substrate supply step of supplying two substrates of a belt shape to two sides of the endless belt with respect to the pile yarns wound around the endless belt;
an adhering step of contacting the supplied substrate with the pile yarns and adhering the substrate to the pile yarns by ultrasonic wave vibration;
a cutting step of cutting an intermediate portion of pile yarns at opposite surfaces of the endless belt; and
a separation step of separating the pile yarns and the substrate away from the endless belt.

15. The method according to claim 14, wherein the ultrasonic wave vibration is applied to each substrate from two sides of the endless belt.
